(19) United States
(12) Patent Application Publication
(10) Pub. No.: US 2004/0044504 A1
(43) Pub. Date: Mar. 4, 2004

(54) Analysis support apparatus

(75) Inventor: Koichi Shimizu, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/645,481

(22) Filed: Aug. 22, 2003

(30) Foreign Application Priority Data
Aug. 30, 2002 (JP) 2002-252928

(51) Int. Cl. G06F 7/60

(52) U.S. Cl. 703/2; 700/97

(57) ABSTRACT

Geometric data generated by a CAD device is obtained to allow a user to set the type of an analysis and a necessary parameter for the analysis. The types of parameter and analysis set by the user are configured as header information about the geometric data, and the information is passed to an analytical program for performing the analysis specified by the user.

### BACKGROUND OF THE INVENTION

1. Field of the Invention

The present invention relates to an analysis support apparatus for supporting an analysis, for example, a numerical analysis.

2. Description of the Related Art

Recently, information processing devices have made remarkable progress, and the functions of the earlier mainframes have been realized by personal computers these days. With the widespread use of information processing devices, manufacturers who produce and design various devices have aimed at improving the efficiency in production, and implemented the information processing devices. Especially, the design of the device referred to as CAD (computer-aided design) using the information processing devices has been widely used and popularized in designing various devices.

However, the structure of a device designed by the CAD device, etc. is managed as a set of geometric data. There are no problems if a designer is allowed to arbitrarily determine the configuration of the device. However, there are normally some problems of items to be optimized by diverging the heat possibly generated by a part of a device, etc. In this case, the designer normally performs a necessary simulation using data of the structure of the device generated by the CAD device, etc., and amends the structure of the device. The simulation includes various types of analyses such as an analysis of the state of thermal conduction, an analysis of the strength of a structure under various conditions, etc. Programs (software) suitable for each of the analyses have been developed.

In the arithmetic operation performed using the above mentioned analysis program (software), geometric data obtained from the CAD device, etc. can be used as is, but the computation amount becomes higher when the geometries are more complicated, and a long time is required to obtain a result, thereby performing an impractical operation. In this case, the geometries can be simplified to a certain extent with the trade-off between the analysis precision and the complexity of the geometries used in the analysis taken into account. In this case, a process of representing a geometry in a mesh pattern is frequently used. Geometric data representing various shapes can be simplified into a mesh pattern of a predetermined size of lattice. The scales of the lattice is empirically determined by a user who performs an analysis.

The mesh pattern has been generated by a user generating analytical data using a mesh generation tool (analytical file generation tool) exclusive for each analysis. However, as described above, a mesh pattern has been empirically generated by the user, and a number of amendments are to be made to the generated mesh to obtain the optimum analytical result, thereby requiring a number of process steps.

Furthermore, in the conventional technology. it has been necessary to input data of necessary properties for the analysis to the analytical program having the mesh generation facility. That is, when an analysis is performed by plural types of analysis programs on the geometry of a device to be analyzed, it has been necessary to input necessary data for the analyses to the respective analytical programs.

Therefore, when data for the same properties are used among a plurality of analysis programs, the respective analysis programs requires inputting the same data, and when various types of analyses are performed, the number of steps of input operations increases proportional to the number of analyses, thereby requiring a large number of inputting steps and long working time to obtain analytical results.

Conventionally, a user has generated a mesh using a corresponding mesh generation software for each of the fluid analysis, structure analysis, electromagnetic field analysis, etc. When a mesh is generated, a model is simplified corresponding to a fluid, structure, electromagnetic field analysis, etc. However, a long time is required to delete and correct the basic geometric data (parts shape data) Furthermore, a different piece of mesh generation software is required for each analysis, and the analyzer takes a long time to learn each pieces of software.

### SUMMARY OF THE INVENTION

The present invention aims at solving the above mentioned problems and providing an analysis support apparatus when an analysis is performed using geometric data.

The analysis support apparatus according to the present invention performs an analysis using geometric data to check the characteristics of the structure represented by the geometric data, and includes a specifying unit for specifying one or more types of analyses from among plural types of analyses, an obtaining unit for obtaining necessary conditions from among necessary analytical conditions of the plurality of analyses based on the specified types of analyses, and a generating unit for generating analytical data formed by at least the obtained analytical conditions and the geometric data corresponding to the specified types of analyses.

According to the analysis support apparatus of the present invention, the user manually operates data in less process steps as compared with the conventional technology, thereby efficiently performing an analysis.

### BRIEF DESCRIPTION OF THE DRAWINGS

FIG. 1 shows the entire configuration of the system containing the analysis support apparatus, and the input information according to the embodiments of the present invention;

FIG. 2 shows an example of a parts move/delete specification input screen;

FIG. 3 shows an example of a user-selected analyzing method screen;

FIG. 4 shows an example of an upper limit mesh size specification screen;

FIG. 5 shows an example of a parts boundary contact specification screen;

FIG. 6 shows an example of a shell specification screen;

FIG. 7 shows an example of a wavelength specification screen;

FIG. 8 shows an example (1) of a statistic parameter specification screen;

FIG. 9 shows an example (2) of a statistic parameter specification screen;

FIG. 10 shows an example of a parts weight setting screen;

FIGS. 11A and 11B show geometric data;

FIG. 12 shows the correlation between the type of an analysis and the name of necessary property;

FIG. 13 is a flowchart of the analytical data generating process according to an embodiment of the present invention;

FIG. 14 is a detailed flowchart of the process in step S19 shown in FIG. 13;

FIG. 15 is a flowchart of an analytical condition setting process in step S11 shown in FIG. 13;

FIG. 16 shows the data structure of analytical data; and

FIG. 17 shows the hardware environment of an information processing device required when an embodiment of the present invention is realized by a program.

### DESCRIPTION OF THE PREFERRED EMBODIMENTS

Conventionally, geometric data (polygon data, CAD data (solid data),) represents a structure to be analyzed. However, no analyzing method for an analysis target indicating the analysis to be performed on the analytical condition, or no information about the analyzing method have been provided. The embodiments of the present invention provides the analysis support apparatus for analyzing the characteristic of a structure represented by the geometric data, and includes: a specifying unit for specifying one or more types of analyses from among plural types of analyses; an obtaining unit for obtaining necessary conditions from among necessary analytical conditions of the plurality of analyses; and a generating unit for generating analytical data formed by at least the obtained analytical conditions and the geometric data corresponding to the specified types of analyses.

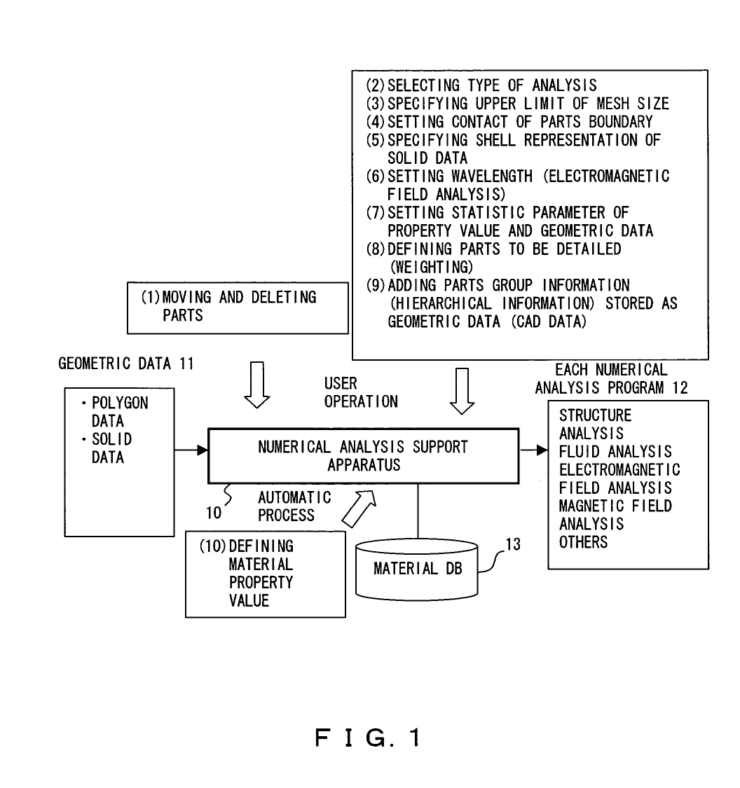

FIG. 1 shows the entire configuration of the system containing the analysis support apparatus which is the analysis device according to the present invention, and the input information according to the embodiments of the present invention.

An analysis support apparatus 10 receives geometric data 11 obtained from a CAD device, etc. The geometric data 11 does not specifically indicate the data of a specific format. Normally, the geometric data is assumed to be formed by polygon data and solid data. The solid data is, for example, generated by a CAD device.

The polygon data is formed by coordinate data for determining geometry and plane data. The solid data is formed by coordinate data, side data, plane data, and three-dimensional data

When the geometric data 11 is input, the analysis support apparatus 10 receives the items (1) through (9) in the user operation. Furthermore, it reads the material property value definition (10) of the device represented by the geometric data to be analyzed from material database 13, and allows the user to select a definition value required in the analysis from among a plurality of material property value definitions.

The values of the items (1) through (10) selected in the user operation are added as an analytical condition to the top of the geometric data as header data. Then, the geometric data with the header data is passed to the analysis program selected by the user from each analysis program 12, and a predetermined analytical calculation is performed under control of the user.

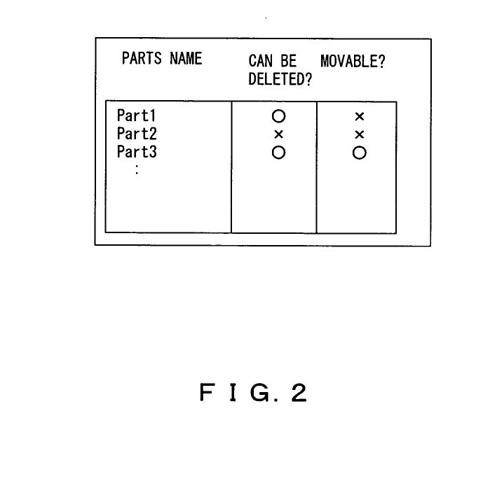

FIG. 2 shows an example of a parts move/delete specification input screen.

The parts move/delete specification indicates that when a shape is detected in the original geometric data, but does not have a significant influence on an analysis, it can be moved or deleted when analytical mesh data is generated in order to simplify mesh data, the analytical computation amount can be reduced, and a high speed analyzing process can be performed. Normally, an analysis target is an actual device having a complicated geometry, and has a plurality of parts. Therefore, when analytical mesh data is generated from among a plurality of parts forming the device, a screen on which parts which can be moved or deleted can be specified by the user is shown in FIG. 2.

The geometric data of an object to be analyzed is managed for each block. Therefore, the geometric data in one part is indicated as a group of data. In this example, the parts names Part1, Part2, and Part3 are indicated as parts data. In the columns of ‘delete’ and ‘movable’ to the right of the parts names, it is specified whether or not each of the parts can be deleted or moved. By clicking the mouse in the corresponding positions in the ‘delete’ and ‘movable’ columns, ‘o’ and ‘x’ can be switched by a toggle.

In the case shown in FIG. 2, Part1 can be deleted, but cannot be move, Part2 cannot be deleted or moved, and Part3 can be deleted and moved.

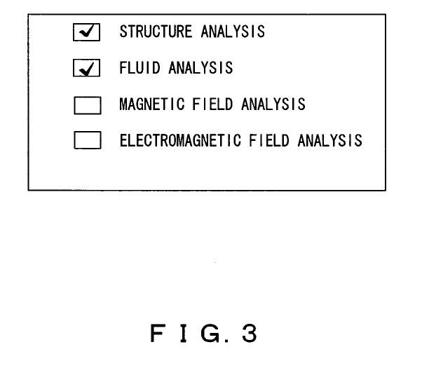

FIG. 3 shows an example of a user-selected analyzing method screen.

In the case shown in FIG. 3, four analyzing methods, that is, a structure analysis, a fluid analysis, a magnetic field analysis, and an electromagnetic field analysis, can be applied. The user can select a plurality of analyzing methods. In FIG. 3, the structure analysis and the fluid analysis are selected.

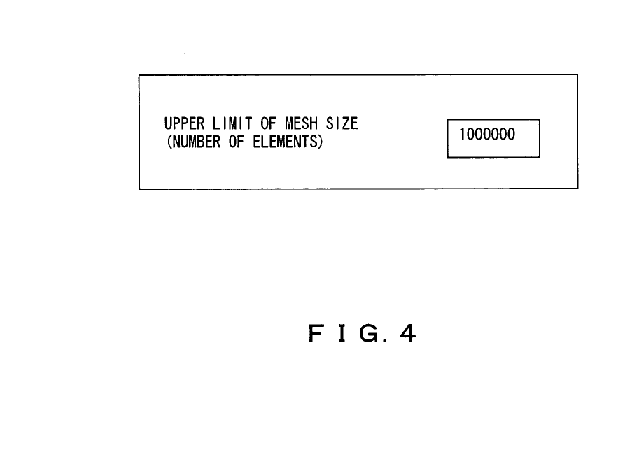

FIG. 4 shows an example of an upper limit mesh size specification screen. When an analysis is performed, an appropriate mesh designing process is performed for a specified analysis, and a numerical caluculation is performed in the geometry simplified by the mesh. At this time, if the size of the mesh is arbitrarily set, the size of the mesh is reduced, and can be scaled down to the original geometric data. In this case, the analytical computation amount becomes the highest in the analysis, and the correct analytical result can be obtained. However, the process is not efficiently performed. Therefore, by setting the upper limit for the total number of meshes, the limit can be set to the mesh. Thus, in the numerical analysis, the high analysis precision and the shortened processing time can be obtained.

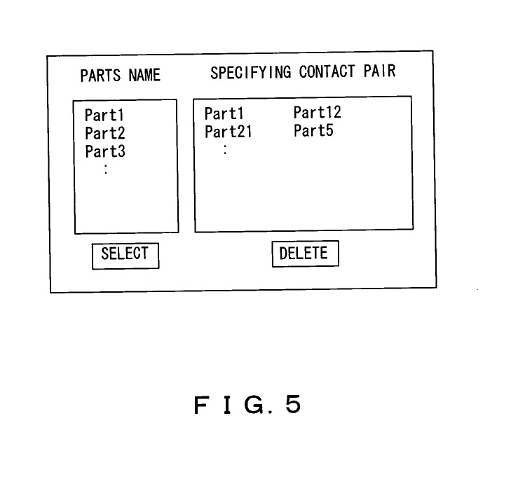

FIG. 5 shows an example of a parts boundary contact specification screen.

The geometric data generated by a CAD device, etc. is segmented into parts. Therefore, although a part contacts another part, or they are fixed with an adhesive, the geometric data is separately defined for each part. Therefore, when an analysis is performed on a thermal conducting system between a part and another part, it is difficult to perform a calculation if the parts are defined individually. Therefore, the parts contacting each other or fixed to each other are specified on the screen shown in FIG. 5, and when a mesh pattern obtained as a simplified form for analysis is obtained, a shape model is generated such that a part of points of both parts can be shared. Thus, when a model is generated such that a part of points can be shared, both parts can be processed as geometric data forming one part.

In FIG. 5, the parts name Part1, Part2, Part3, etc. are listed, and Part1 and Part12 contact each other as specified as a contact pair, and part21 and part 5 contact each other. They are specified by the user using a selection button and a deletion button. For example, after selecting Part1 and Part2 using a mouse cursor, etc. from a parts name list, the selection button is clicked, thereby specifying them as a contact pair. Furthermore, by clicking the deletion button after selecting desired parts names on the contact pair specification list, the selected parts are released from the pair specification with the contact pair parts.

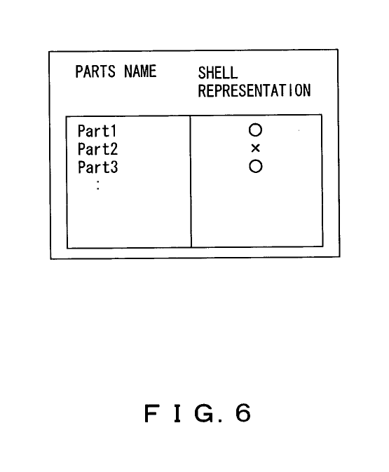

FIG. 6 shows an example of a shell specification screen.

A shell representation refers to, for example, the following process.

Assume that a part is represented as having shape of a thin iron plate in the original geometric data. Since the part is very thin, it is more easily understood as having no conductivity in the thickness direction when the state of the thermal conductivity analysis exhibits no inconsistent analytical result. In this case, the geometric data held as having a thin box shape is simplified in shape as a two-dimensional plane having no thickness in the mesh procedure in an analyzing process. The above mentioned process is referred to as a shell representation.

It is obvious that the above mentioned shell representation can be applied or cannot be applied depending on what condition is applied or what analysis is performed. Therefore, as shown in FIG. 6, a user specifies whether or not the shell representation of each part is acceptable by marking ‘OK’ for Part1, ‘NG’ for Part2, ‘OK’ for Part3, etc. The specification of ‘OK’ or ‘NG’ for shell representation can be changed with a toggle by clicking the position corresponding to the part name as in the process shown in FIG. 2.

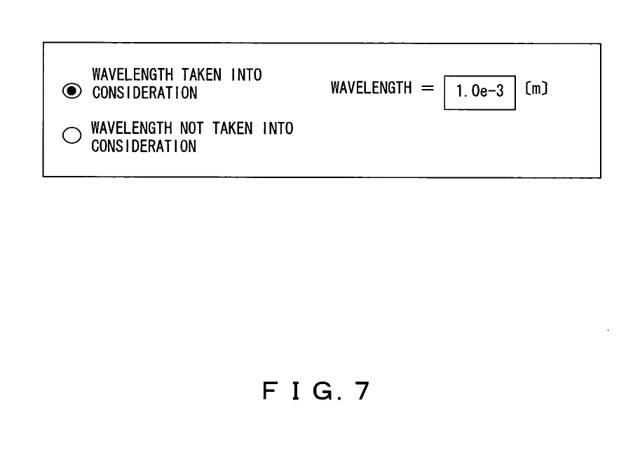

FIG. 7 shows an example of a wavelength specification screen.

In an electromagnetic field analysis, the configuration of a size shorter than a wavelength of an electromagnetic wave emitted to an analysis target in the configuration of the analysis target is known as having no significant influence on an analytical result. Therefore, when a mesh is segmented in the analysis, an instruction to or not to consider a wavelength, and, if it is to be considered, an instruction to set the size of the wavelength are to be issued.

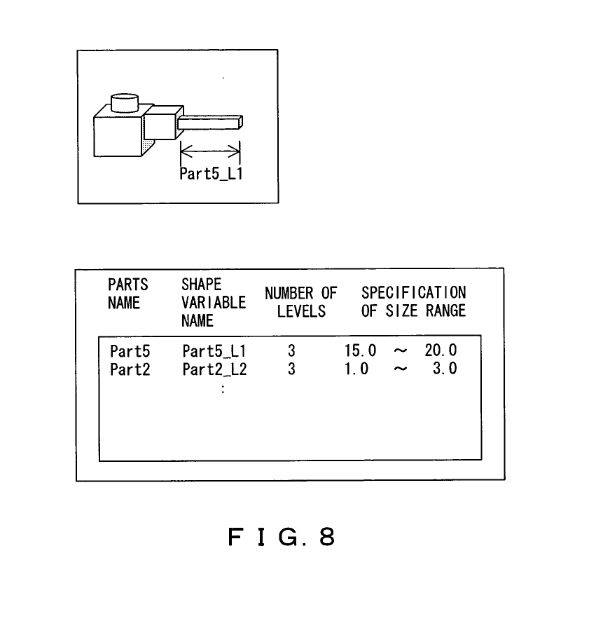

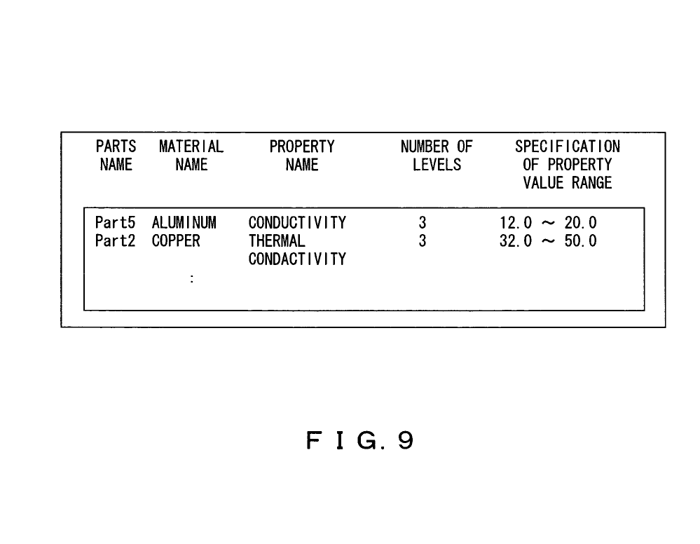

FIGS. 8 and 9 show examples of statistic parameter specification screens.

FIG. 8 shows an example of a shape statistic parameter specification screen.

In this case, the analysis of the variations of the length of Part5_L1 shown on the left in FIG. 8 is indicated by the number of levels, and the variable length of Part5_L1 is set to the range from 15.0 to 20.0. This indicates that analyses are performed and the respective analytical results are obtained when Part5_L1 is 15.0, 17.5, and 20.0. Thus, the optimum length of Part5 can be selected from among a plurality of trials.

Similarly, it is specified that the length of Part2_L2 of the Part2 on the right in FIG. 8 is analyzed in three trials. Part2_L2 is to be changed from 1.0 to 3.0. If 1.0 and 3.0 are selected for Part2_L2 in the number of levels of 3, then the remaining value is reasonably 2.0. However, the value is not limited to 2.0, and the selection from among the three values can be specified by the user. This holds true also with the above mentioned Part5_L1. The ‘number of levels’ column and the ‘size scope specification’ column corresponding to the parts name are fields into which a numeral can be input, and the user inputs desired values into these fields.

FIG. 9 shows an example of a parts material property parameter screen.

In this case, the physical size of parts is represented by a parameter and analyzed in several cases in FIG. 8. In FIG. 9, the property value of a part is represented by a parameter, and analyzed in several cases. For example, in the case of the part of Part5, the material name is aluminum, the property name is conductivity, the number of levels (same as described above) of 3, and the property value ranges from 12.0 to 20.0. Therefore, the part of Part5 is made of aluminum, and is analyzed with the three values of conductivity in the range from 12.0 to 20.0. Simultaneously, Part2 is set to the material name of copper, the number of levels of 3, the thermal conductivity for a property name, and the property value ranging 32.0 to 50.0. As in FIG. 8, the ‘number of levels’ column and the ‘property value range’ column are fields into which a numeral can be input.

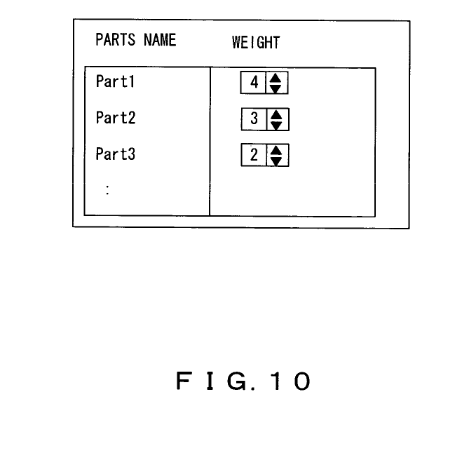

FIG. 10 shows an example of a parts weight setting screen.

In FIG. 10, the weight of the part of Part1 is set to 3, and the weight of the part of Part2 is set to 2.

The weight refers to a value specifying the level of easily changing or deleting the shape of a weight part when the weighted part is moved or changed. For example, when data is represented at five weight levels from 1 to 5, the following suggestion can be presented.

weight 1: to be deleted

weight 2: can be deleted

weight 3: cannot be deleted, can be shape-changed

weight 4: cannot be deleted, can be shape-changed (only the volume smaller

than a predetermined rate can be changed)

weight 5: cannot be deleted, cannot be shape-changed

Based on the above mentioned determination, parts can be sequentially deleted or shape-changed from those that can be easily deleted or shape-changed. Therefore, the parts which are not to be deleted or shape-changed are deleted or shape-changed only when they are inevitably deleted or shape-changed. The ‘weight’ column is provided corresponding to each name of a part controllable for increase or decrease within the above mentioned numeral range, and the user can perform an operation under the control.

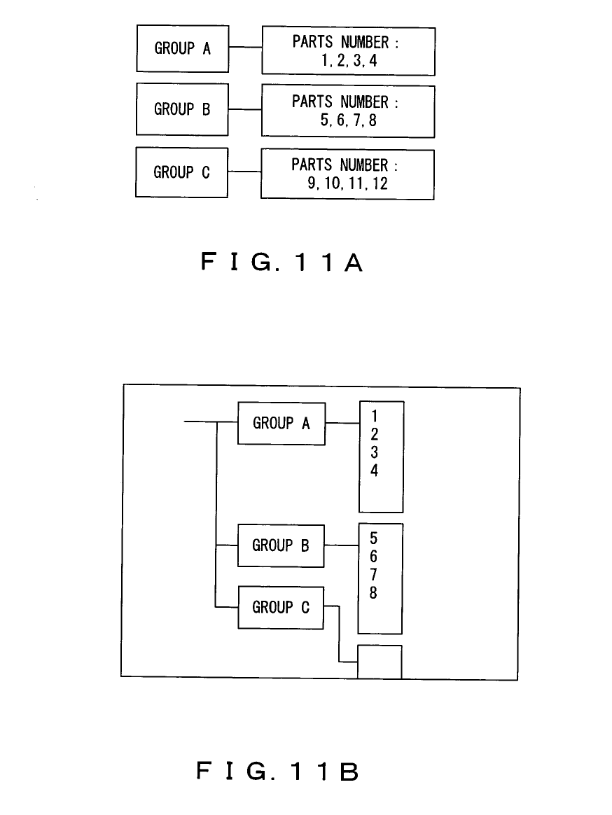

FIGS. 11A and 11B show geometric data.

The geometric data is arranged for each part, a plurality of parts form a group, and a plurality of groups form an upper set, thus forming a tree structure. In the example of the geometric data shown in FIG. 11A, a group A includes the parts having the parts numbers 1, 2, 3, and 4, a group B includes the parts having the parts numbers 5, 6, 7, and 8, and a group C includes the parts having the parts numbers 9, 10, 11, and 12. The method of displaying geometric data having the above mentioned tree structure can be realized by the branching of the groups A through C under the root, and arranging and storing the numbers of the parts under each of the groups A through C represented as a tree structure as shown in FIG. 11B. With the configuration, the part regarded by the user can be clearly detected as belonging to which part of the device.

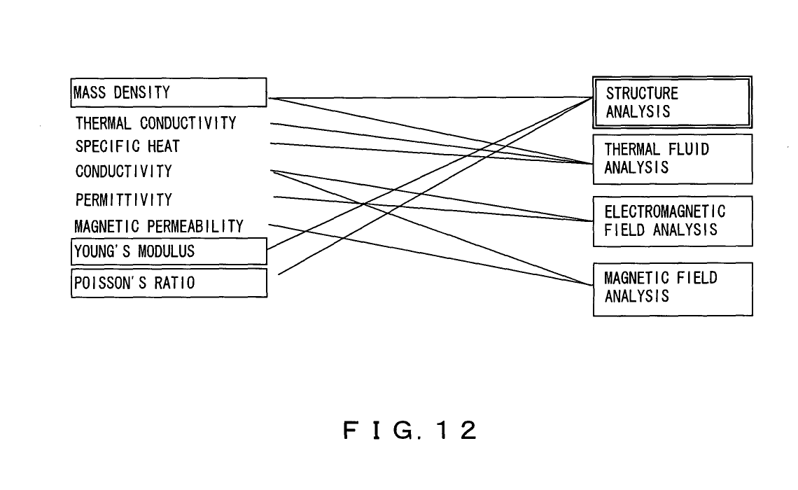

FIG. 12 shows the correlation between the type of an analysis and the name of necessary property.

In the material database, the information about each analyzing method corresponding to each material is recorded. In FIG. 12, the mass density, the thermal conductivity, the specific heat, the conductivity, the permittivity, the magnetic permeability, the Young's modulus, and the Poisson's ratio are listed as property names. In addition, the structure analysis, the thermal fluid analysis, the electromagnetic field analysis, and the magnetic field analysis are listed as analyzing methods.

The property name of the material required in an analysis depends on a type of analysis. For example, the mass density, the Young's modulus, and the Poisson's ratio are required in the structure analysis. Similarly, the mass density, the thermal conductivity, and the specific heat are required in the thermal fluid analysis. The conductivity and the permittivity are required in the electromagnetic field analysis. The conductivity and the magnetic permeability are required in the magnetic field analysis.

Thus, since required property names depend on each analyzing method, the property values of necessary property names are obtained from the material database, and are passed as parameters to the program for the corresponding analysis when the user specifies an analyzing method in the analysis support apparatus according to the embodiments of the present invention.

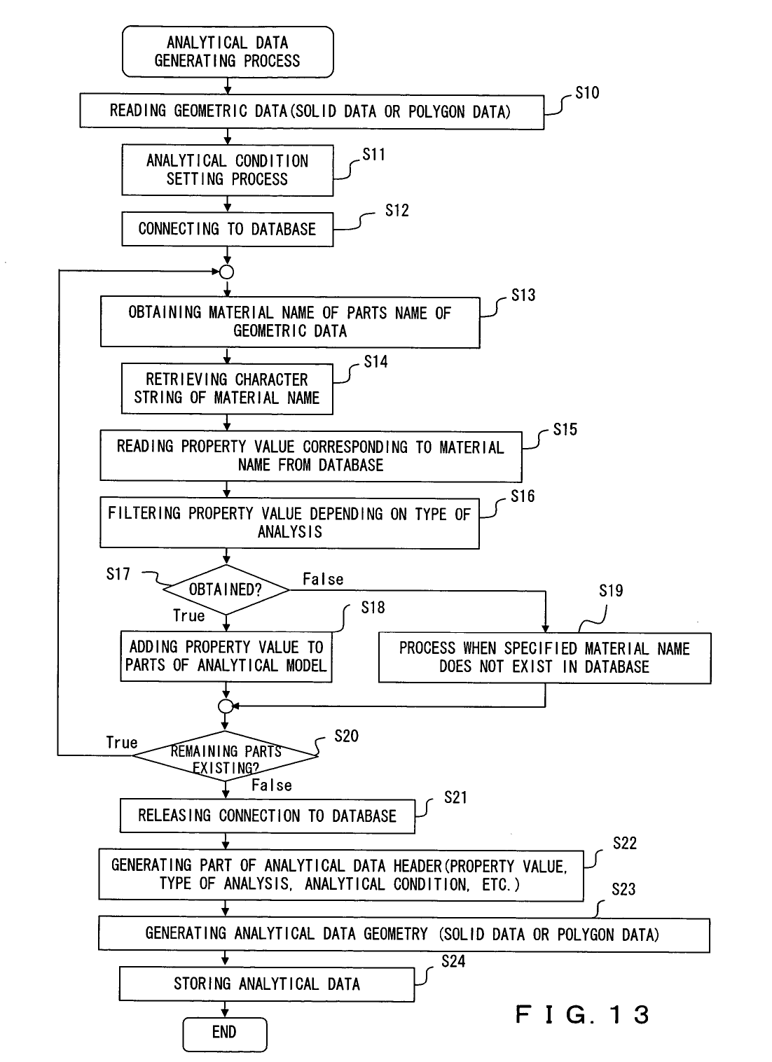

FIG. 13 is a flowchart of the analytical data generating process according to an embodiment of the present invention. When a plurality of analysis types are specified, the process is performed for each analysis type.

In step S10, the geometric data held as solid data or polygon data is read. In step S11, the analytical condition setting process is performed. Then, in step S12, a material database is connected. In step S13, the material name of the parts name of shape data is obtained. In step S14, a character string of the material name is retrieved from the material database. In step S15, a property value corresponding to the material name is read out from the material database. In step S16, the property value is filtered depending on the analysis type. That is, only a necessary property value is obtained depending on the type of analysis.

In step S17, it is determined whether or not the property value has been successfully obtained. If the determination in step S17 is false, then control is passed to step S19, and the process for the case in which no material name specified for the material database exists is performed. If the determination in step S17 is true, then a property value is added as an attribute of the part of the analytical model is added in step S18. In step S20, it is determined whether or not there is a remaining part. If the determination in step S20 is true, then control is returned to step S13 to repeat the processes. If the determination in step S20 is false, then control is passed to step S21.

In step S21, the connection to the material database is released, and an analytic data header unit is generated in step S22. The analytical data header stores the property value, the type of analysis, the analytical condition, etc. In step S23, an analytical data geometry unit formed by solid data or polygon data is generated. In step S24, analytical data in the form of the analytical data geometry unit provided with an analytical header is stored, thereby terminating the process.

The generated analytical database is read by the corresponding analytical program, and a mesh is generated based on the contents of the analytical header.

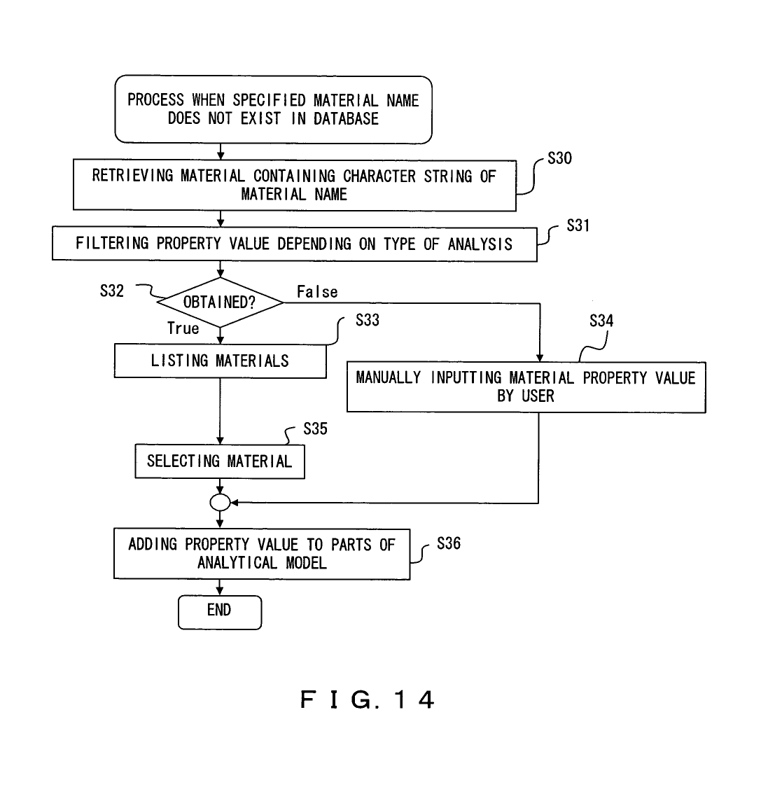

FIG. 14 is a detailed flowchart of the process in step S19 shown in FIG. 13.

In step S30, the material including a character string of the material name is retrieved from the material database. In step S31, the property value is filtered depending on the type of analysis. In step S32, it is determined whether or not a property value has been obtained. If the determination in step S32 is false, then the user manually inputs the material property value in step S34, and control is passed to step S36.

If the determination in step S32 is true, then materials are listed in step S33, and the user is allowed to select an appropriate material in step S35. In step S36, the property value is added as an attribute to the part of the analytical model, and control is returned to the flowchart shown in FIG. 13.

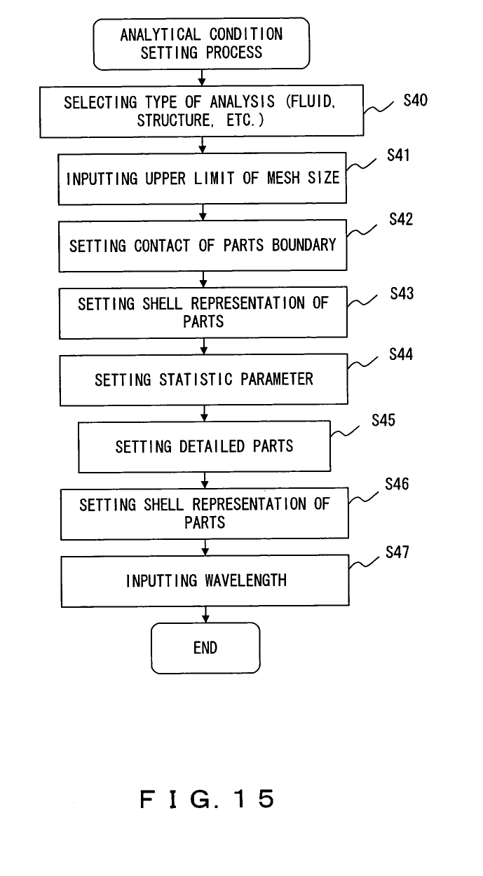

FIG. 15 is a detailed flowchart of the analytical condition setting process in step S11 shown in FIG. 13.

First, in step S40, the type of analysis (fluid analysis, structure analysis, etc.) is selected by a user. Then, in step S41, the user is allowed to input an upper limit of a mesh size. In step S42, the setting of contact of a part boundary is performed by the user. In step S43, the user sets the shell representation for parts. Furthermore, in step S44, the user is allowed to set a statistic parameter. In step S45, the detailed parts settings are performed by the user. In step S46, the user sets the shell representation for the parts. In step S47, a wavelength is input by the user, thereby terminating the process.

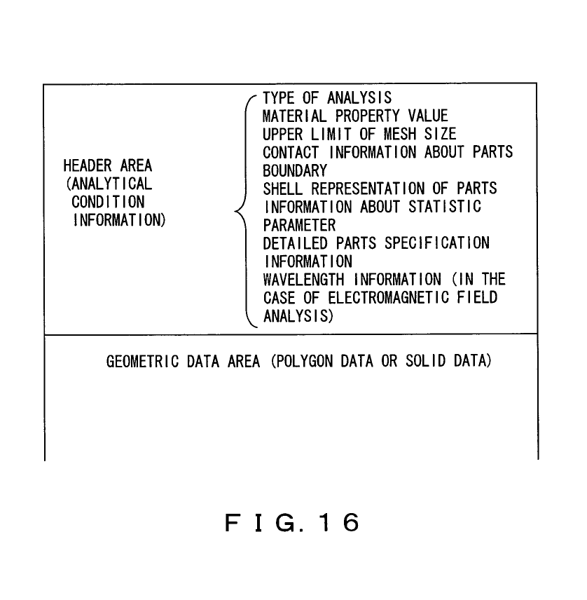

FIG. 16 shows the data structure of analytical data.

The header area stores analytical condition information. Analytical condition information includes the type of analysis, the material property value, the upper limit of a mesh size, the contact information about a parts boundary, the shell representation information about parts, the statistic parameter information, the detailed parts specification information, the wavelength information (in the case of the electromagnetic field analysis), etc.

In the area next to the header, a geometric data area formed by polygon data or solid data is provided.

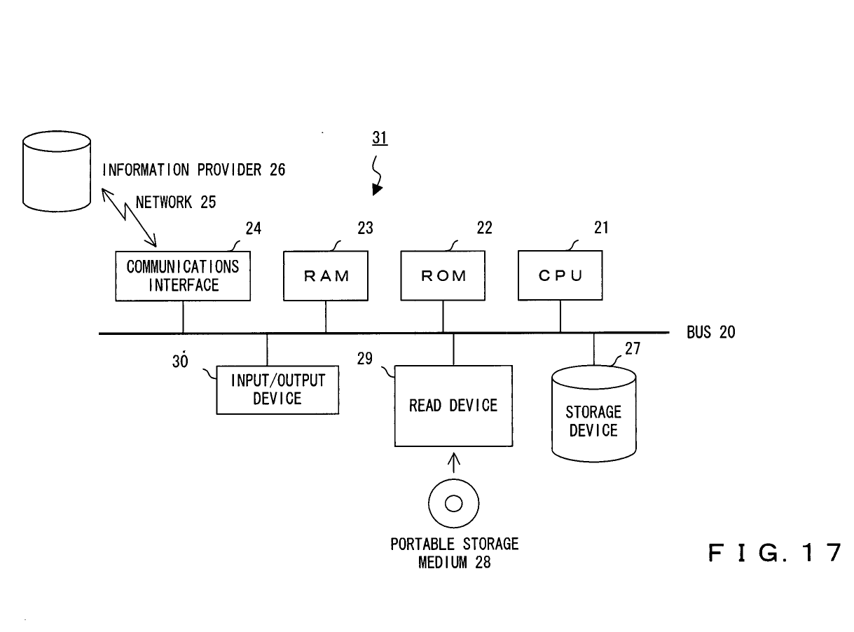

FIG. 17 shows the hardware environment of an information processing device required when an embodiment of the present invention is realized by a program.

An information processing device 31 realizes a predetermined process by a CPU 21 which is connected to a bus 20 and executes a program read from RAM 23 or ROM 22 through the bus 20. A program stored in a storage device 27 such as a hard disk, etc. and a program stored in a portable storage medium 28 are copied to the RAM 23, and is executed by the CPU 21. The portable storage medium 28 can be CD-ROM, a DVD, an MO, a flexible disk, etc. to which a program stored is read by a read device 29, and the program is copied to the RAM 23.

An input/output device 30 is formed by a keyboard, a mouse, a template, a touch plate, a display, etc., and an operator of the information processing device 31 inputs information through the input/output device 30 and receives a process result from it.

A communications interface 24 connects the information processing device 31 to an information provider 26 through a network 25, and realizes a style of execution such as downloading and executing a program from the information provider 26, executing a program in a network environment, etc.

The present invention can provide an analysis support apparatus capable of more easily preparing necessary data for an analysis to be performed when an analysis such as a structure analysis, a thermal fluid analysis, etc. is to be performed using geometric data. Furthermore, when a plurality of analyses are performed, an analytical database can be obtained in a smaller number of process steps within a shorter time.

What is claimed is:

1. An analysis support apparatus for performing an analysis using geometric data to check characteristics of a structure represented by the geometric data, comprising:
a specifying unit specifying one or more types of analyses from among plural types of analyses;
an obtaining unit obtaining necessary conditions from among necessary analytical conditions of the plurality of analyses based on the specified types of analyses; and
a generating unit generating analytical data formed by at least the obtained analytical conditions and the geometric data corresponding to the specified types of analyses.

2. The apparatus according to claim 1, wherein
said analytical data is generated using the obtained analytical conditions as header information about the geometric data.

3. The apparatus according to claim 1, wherein
said analytical conditions are extracted by selecting a type of a property of a structure indicated by the geometric data and a corresponding property value.

4. The apparatus according to claim 1, wherein
said analytical conditions include an upper limit of a mesh size when a mesh is generated to obtain analytical data.

5. The apparatus according to claim 1, wherein
said analytical conditions include a contact setting of a part boundary.

6. The apparatus according to claim 1, wherein
said analytical conditions include a plurality of dimension values or property values provided for selection of an optimum value.

7. The apparatus according to claim 1, wherein
said analytical conditions include settings of a shell representation of parts geometric data and of parts weights.

8. The apparatus according to claim 1, wherein
said analytical conditions include a wavelength of an electromagnetic field in an electromagnetic analysis.

9. An analysis supporting method for performing an analysis using geometric data to check characteristics of a structure represented by the geometric data, comprising:
a specifying step of specifying one or more types of analyses from among plural types of analyses;
an obtaining step of obtaining necessary conditions from among necessary analytical conditions of the plurality of analyses based on the specified types of analyses; and
a generating step of generating analytical data formed by at least the obtained analytical conditions and the geometric data corresponding to the specified types of analyses.

10. The method according to claim 9, wherein
said analytical data is generated using the obtained analytical conditions as header information about the geometric data.

11. The method according to claim 9, wherein
said analytical conditions are extracted by selecting a type of a property of a structure indicated by the geometric data and a corresponding property value.

12. The method according to claim 9, wherein
said analytical conditions include an upper limit of a mesh size when a mesh is generated to obtain analytical data.

13. The method according to claim 9, wherein
said analytical conditions include a contact setting of a part boundary.

14. The method according to claim 9, wherein
said analytical conditions include a plurality of dimension values or property values provided for selection of an optimum value.

15. The method according to claim 9, wherein
said analytical conditions include settings of a shell representation of parts geometric data and of parts weights.

16. The method according to claim 9, wherein
said analytical conditions include a wavelength of an electromagnetic field in an electromagnetic analysis.

17. An analysis supporting program for directing an information processing device to realize an analysis supporting method for performing an analysis using geometric data to check characteristics of a structure represented by the geometric data, comprising:
a specifying step of specifying one or more types of analyses from among plural types of analyses;
an obtaining step of obtaining necessary conditions from among necessary analytical conditions of the plurality of analyses based on the specified types of analyses; and
a generating step of generating analytical data formed by at least the obtained analytical conditions and the geometric data corresponding to the specified types of analyses.

18. The program according to claim 17, wherein
said analytical data is generated using the obtained analytical conditions as header information about the geometric data.

19. The program according to claim 17, wherein
said analytical conditions are extracted by selecting a type of a property of a structure indicated by the geometric data and a corresponding property value.

20. The program according to claim 17, wherein
said analytical conditions include an upper limit of a mesh size when a mesh is generated to obtain analytical data.

21. The program according to claim 17, wherein
said analytical conditions include a contact setting of a part boundary.

22. The program according to claim 17, wherein
said analytical conditions include a plurality of dimension values or property values provided for selection of an optimum value.

23. The program according to claim 17, wherein
said analytical conditions include settings of a shell representation of parts geometric data and of parts weights.

24. The program according to claim 17, wherein
said analytical conditions include a wavelength of an electromagnetic field in an electromagnetic analysis.

25. The apparatus according to claim 1, wherein
said generating unit further generates the analytical data formed by the specified types of analyses.

26. The method according to claim 9, wherein
said generating step further generates the analytical data formed by the specified types of analyses.

27. The program according to claim 17, wherein
said generating step further generates the analytical data formed by the specified types of analyses.

28. The apparatus according to claim 1, wherein
said obtaining unit obtains a property value which is a necessary analytical condition in the specified analysis from a material database.

29. The method according to claim 9, wherein
said obtaining step obtains a property value which is a necessary analytical condition in the specified analysis from a material database.

30. The program according to claim 17, wherein
said obtaining step obtains a property value which is a necessary analytical condition in the specified analysis from a material database.
